(19) United States
(12) Patent Application Publication
(10) Pub. No.: US 2018/0074528 A1
(43) Pub. Date: Mar. 15, 2018

(54) LOW-PRESSURE REGULATOR

(71) Applicant: NIKKI CO., LTD., Kanagawa - ken (JP)

(72) Inventors: Tatsunori HASHIMOTO, Kanagawa - ken (JP); Yukio ISHIDA, Kanagawa - ken (JP)

(21) Appl. No.: 15/701,360

(22) Filed: Sep. 11, 2017

(30) Foreign Application Priority Data
Sep. 12, 2016 (JP) 2016-177935

(51) Int. Cl. G05D 16/06

(52) U.S. Cl. CPC G05D 16/0697; F02M 21/0239

(57) ABSTRACT

A pressure regulating chamber and an atmospheric pressure chamber are divided with a diaphragm, a pressure regulating lever connected to the diaphragm through a diaphragm pin is included in the pressure regulating chamber, and a valve element provided in a tip end side of the pressure regulating lever regulates a fuel in the pressure regulating chamber to have a predetermined pressure near an atmospheric pressure and sends the fuel while opening or closing a fuel introduction port, as the pressure regulating lever swings following displacement of the diaphragm. Connection on the pressure regulating lever side or connection on the diaphragm side, of the diaphragm pin, is separable within a predetermined range in the atmospheric pressure chamber direction. The diaphragm pin is separated to cancel the connection between the diaphragm and the pressure regulating lever when at least the pressure regulating chamber has a positive pressure of a predetermined level or more.

### CROSS-REFERENCE TO RELATED APPLICATION

This application claims priority to a Japanese Patent Application No. 2016-177935 filed on Sep. 12, 2016, the contents of which are hereby incorporated by reference in its entirety.

### Technical Field

The present invention relates to a low-pressure regulator that regulates a gas-fuel to have a predetermined pressure close to an atmospheric pressure and sends the gas-fuel.

### RELATED ART

### Background

A high-pressure gas-fuel stored in a fuel tank is typically regulated to have a fixed pressure close to the atmospheric pressure regardless of pressure change on a supply source or flow rate change on the consumer side when the gas-fuel such as a natural gas or a propane gas is supplied to an engine. As a device therefor, a low-pressure regulator 1C as illustrated in FIG. 6 is known.

In the low-pressure regulator 1C, a pressure regulating chamber 13 and an atmospheric pressure chamber 14 are divided with a diaphragm 12, and a base end side of a pressure regulating lever 15C is connected to a central portion of the diaphragm 12 through a diaphragm pin 123. A tip end-side valve element 150 regulates a fuel pressure in the pressure regulating chamber 13 to near the atmospheric pressure while opening or closing a fuel introduction port 16a, which is a fuel introduction path 16 open to the pressure regulating chamber 13 side, as the pressure regulating lever 15C swings following displacement of the diaphragm 12.

However, in this type of low-pressure regulator 1C, the base end side of the pressure regulating lever 15C is coupled with the diaphragm 12 through the diaphragm pin 123. Therefore, there is a problem that, in a case where backfire or the like occurs and the pressure regulating chamber 13 becomes an abnormal positive pressure state, and the diaphragm 12 is substantially displaced to the atmospheric pressure chamber 14 side and an excess load is applied to the pressure regulating lever 15C, as illustrated in FIG. 7, deformation/damage of the pressure regulating lever 15C is incurred and open and close operations of the valve become defective, and desired pressure regulating performance cannot be maintained.

In contrast, for example, as illustrated in FIG. 1 of JP 2009-41549 A, a low-pressure regulator that can avoid application of an excess load to a pressure regulating lever, even if a diaphragm is excessively displaced toward an atmospheric pressure chamber, is presented, with a configuration in which a protrusion member provided in the center of the diaphragm comes in contact with and presses a base end side of the pressure regulating lever to open a valve, and the protrusion member is away from the base end side of the pressure regulating lever when the diaphragm is displaced toward the atmospheric pressure chamber, that is, the pressure regulating lever is separable from the diaphragm.

However, in the low-pressure regulator presented in JP 2009-41549 A, the diaphragm and the pressure regulating lever are not connected, and the low-pressure regulator employs the system to press the pressure regulating lever to open a valve only when the diaphragm is displaced toward a pressure regulating chamber with a negative pressure. Therefore, even if the diaphragm is displaced toward the atmospheric pressure chamber at a normal operation, the pressure regulating lever does not follow the displacement and does not close the valve. Therefore, there is a problem that pressure regulating performance with high precision is difficult to realize.

### SUMMARY

The present invention solves the above-described problems of the conventional low-pressure regulators, and an objective is to provide a low-pressure regulator that can avoid damage/deformation in a pressure regulating mechanism and can maintain desired pressure regulating performance.

The present invention made to solve the above problems is a low-pressure regulator wherein a pressure regulating chamber and an atmospheric pressure chamber are divided with a diaphragm, a pressure regulating lever connected to the diaphragm through a diaphragm pin is included in the pressure regulating chamber, and a valve element provided in a tip end side of the pressure regulating lever regulates a fuel in the pressure regulating chamber to have a predetermined pressure near an atmospheric pressure and sends the fuel while opening or closing a fuel introduction port, as the pressure regulating lever swings following displacement of the diaphragm, connection on a side of the pressure regulating lever or connection on a side of the diaphragm, of the diaphragm pin, being separable within a predetermined range in a direction of the atmospheric pressure chamber, and the connection between the diaphragm pin and the side of the pressure regulating lever or the connection between the diaphragm pin and the side of the diaphragm being separated to cancel the connection between the diaphragm and the pressure regulating lever, when at least the pressure regulating chamber has a positive pressure of a predetermined level or more.

The present invention has a configuration to separate either side of the diaphragm pin interposed between the diaphragm and the pressure regulating lever to cancel connection between the diaphragm and the pressure regulating lever when the pressure regulating chamber has an abnormal positive pressure. Therefore, an excess load with displacement of the diaphragm is not applied to the pressure regulating pin at the time of the abnormal positive pressure. Therefore, deformation/damage of the pressure regulating mechanism can be avoided, and desired pressure regulating performance can be easily maintained.

Further, the present invention is characterized in that the connection between the diaphragm pin and the side of the pressure regulating lever or the connection between the diaphragm pin and the side of the diaphragm is not separated and the diaphragm pin and the side of the pressure regulating lever or the diaphragm pin and the side of the diaphragm follow each other, when the pressure regulating chamber has a negative pressure, while the connection between the diaphragm pin and the side of the pressure regulating lever or the connection between the diaphragm pin and the side of the diaphragm is separated, when the pressure regulating chamber has the positive pressure of a predetermined level or more, thereby to reliably regulate the gas-fuel to have a predetermined pressure close to the atmospheric pressure.

According to the present invention in which either side of the diaphragm pin interposed between the diaphragm and the pressure regulating lever is separated and the connection between the diaphragm and the pressure regulating lever is cancelled when the pressure regulating chamber has an abnormal positive pressure, damage/deformation in the pressure regulating mechanism can be avoided, and desired pressure regulating performance can be maintained, with the simple configuration.

### BRIEF DESCRIPTION OF DRAWINGS

FIG. 1 is a vertical sectional view illustrating a state of a normal operation of a low-pressure regulator as a first embodiment in the present invention;

FIG. 2 is a vertical sectional view illustrating a state of an abnormal positive pressure state of the low-pressure regulator of FIG. 1;

FIG. 3 is a vertical sectional view illustrating a state of a normal operation of a low-pressure regulator as a second embodiment in the present invention;

FIG. 4 is a vertical sectional view illustrating a state of the low-pressure regulator of FIG. 3 of when a valve is open;

FIG. 5 is a vertical sectional view illustrating an abnormal positive pressure state of the low-pressure regulator of FIG. 3;

FIG. 6 is a vertical sectional view illustrating a state of a low-pressure regulator of a conventional example at a normal operation; and

FIG. 7 is a vertical sectional view illustrating an abnormal positive pressure state of the low-pressure regulator of FIG. 6.

### DETAILED DESCRIPTION

Hereinafter, forms for implementing the present invention will be described with reference to the drawings.

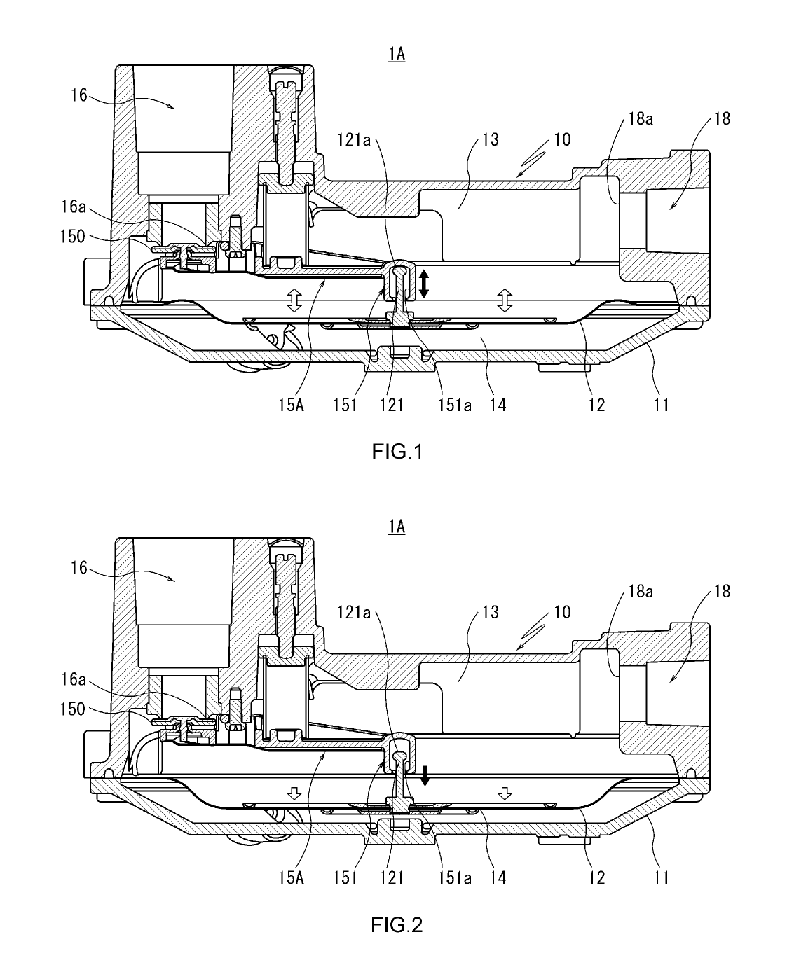

FIG. 1 illustrates a state at a normal operation of a low-pressure regulator 1A as a first embodiment in the present invention. The low-pressure regulator 1A is a device that sends a gas-fuel such as a natural gas or a propane gas while regulating the gas-fuel to have a pressure (0 to 100 Pa) close to an atmospheric pressure, regardless of pressure change of a supply source and flow rate change on a consumer side, similarly to a conventional low-pressure regulator, and is a device with an approximate disk shape as a whole.

Further, in the low-pressure regulator 1A, a cover 11 is mounted while a peripheral edge side of a diaphragm 12 is inserted into an open bottom surface side of a main body 10, and thus a pressure regulating chamber 13 and an atmospheric pressure chamber 14 are divided with the diaphragm 12. A pressure regulating lever 15A having a base end side connected to a central portion side of the diaphragm 12 through a diaphragm pin 121 is arranged inside the pressure regulating chamber 13. The pressure regulating lever 15A and the diaphragm 12 configure a pressure regulating mechanism.

That is, a gas-fuel in the pressure regulating chamber 13 is sent through a fuel sending port 18a open in the pressure regulating chamber 13 and through a fuel sending path 18 while the gas-fuel in the pressure regulating chamber 13 is regulated to have a predetermined pressure, as the pressure regulating lever 15A swings following displacement of the diaphragm 12. A valve element 150 is provided to a tip end side of the pressure regulating lever 15A and is operated to open when the pressure regulating chamber 13 has a predetermined pressure or less (negative pressure) and close when the pressure regulating chamber 13 has a predetermined pressure or more (positive pressure). The valve element 150 regulates the gas-fuel in the pressure regulating chamber 13 to have a fixed pressure near the atmospheric pressure while performing an open or close operation of a fuel introduction port 16a, which is a fuel introduction path 16 open to the pressure regulating chamber 13 side.

Then, connection of the base end side of the diaphragm pin 121 with a joint element 151 is separable within a predetermined range in the direction of the atmospheric pressure chamber 14, and connection between the diaphragm 12 and the pressure regulating lever 15A is cancelled with the separation operation, when at least the pressure regulating chamber 13 has an abnormal positive pressure of a predetermined level or more, so that application of an excess load to the pressure regulating mechanism is prevented and deformation/damage of the pressure regulating mechanism is avoided. Further, when the pressure regulating chamber 13 has a negative pressure, the diaphragm pin 121 and the joint element 151 are not separated and follow each other. With the configuration, the gas-fuel is reliably regulated to have a low pressure.

FIG. 2 illustrates a state in which an abnormal positive pressure is applied to the pressure regulating chamber 13 of the low-pressure regulator 1A due to backfire or the like. In the low-pressure regulator 1A having the structure in which the base end side of the pressure regulating lever 15A and the diaphragm pin 121 are connected, a recessed portion for connection 151a of the joint element 151, into which one end side of the diaphragm pin 121 is inserted, extends in the direction of the atmospheric pressure chamber 14, and an expanded portion 121a formed in the one end side of the diaphragm pin 121 is slidable within a predetermined range in the recessed portion for connection 151a along a longitudinal direction of the diaphragm pin 121.

Therefore, even if the pressure regulating chamber 13 has an abnormal positive pressure and the diaphragm 12 is substantially displaced toward the atmospheric pressure chamber 14, the expanded portion 121a in the base end side of the diaphragm pin 121 is separated from a connection position where the expanded portion 121a abuts against a deepest portion of the recessed portion for connection 151a of FIG. 1 and simply slides in the direction of the atmospheric pressure chamber 14, as illustrated in FIG. 2, and the diaphragm pin 121 does not pull the pressure regulating lever 15A toward the atmospheric pressure chamber 14 by following the displacement of the diaphragm 12. With the configuration, application of an excess load to the pressure regulating lever 15A can be avoided. Further, when the pressure regulating chamber 13 has a negative pressure, the diaphragm pin 121 and the joint element 151 are not separated and follow each other. With the configuration, the gas-fuel can be reliably regulated to have a low pressure.

In this way, with the simple configuration, which is obtained by adding slight improvement to the pressure regulating mechanism of the conventional low-pressure regulator 1C described in FIG. 6, the low-pressure regulator 1A of the present embodiment does not have a possibility of causing deformation/damage in the pressure regulating mechanism mainly including the pressure regulating lever 15A, even in a situation where an abnormal positive pressure is applied to the pressure regulating chamber 13 during operation. Therefore, the pressure regulating performance required for the low-pressure regulator can be easily maintained over a long period of time.

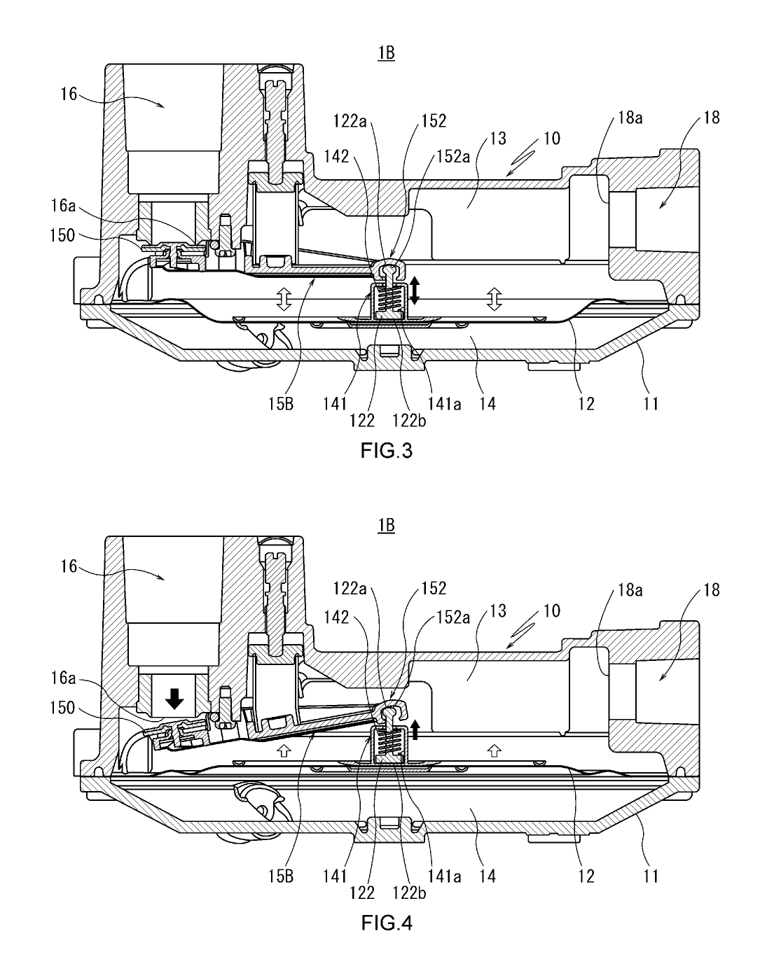

FIG. 3 illustrates a state at a normal operation, of a low-pressure regulator as a second embodiment in the present invention. In the present embodiment, in a connection structure of a diaphragm 12 and a pressure regulating lever 15B, one end side of a diaphragm pin 122 is connected/fixed in a joint element 152 on a base end side of the pressure regulating lever 15B and the other end side of the diaphragm pin 122 is inserted into a recessed portion for connection 141a of a receiving member 141 installed in a protruding manner in a central portion of the diaphragm 12, and the diaphragm pin 122 on the diaphragm 12 side (the other end side) is separable. In addition, the diaphragm pin 122 on the diaphragm 12 side is constantly biased to the direction of the diaphragm 12 with a spring member (helical spring) 142.

In the present embodiment, an expanded portion 122a formed in the one end side of the diaphragm pin 122 is inserted into and connected/fixed to, in a non-separable state, a recessed portion for connection 152a of the joint element 152 formed in the base end side of the pressure regulating lever 15B. An expanded portion 122b formed in the other end side of the diaphragm pin 122 slides from a connection position where the expanded portion 122b abuts against a deepest portion of the recessed portion for connection 141a of the receiving member 141 protruding from the central portion of the diaphragm 12, toward an opening of the recessed portion for connection 141a, in the recessed portion for connection 141a, so that the connection is separated.

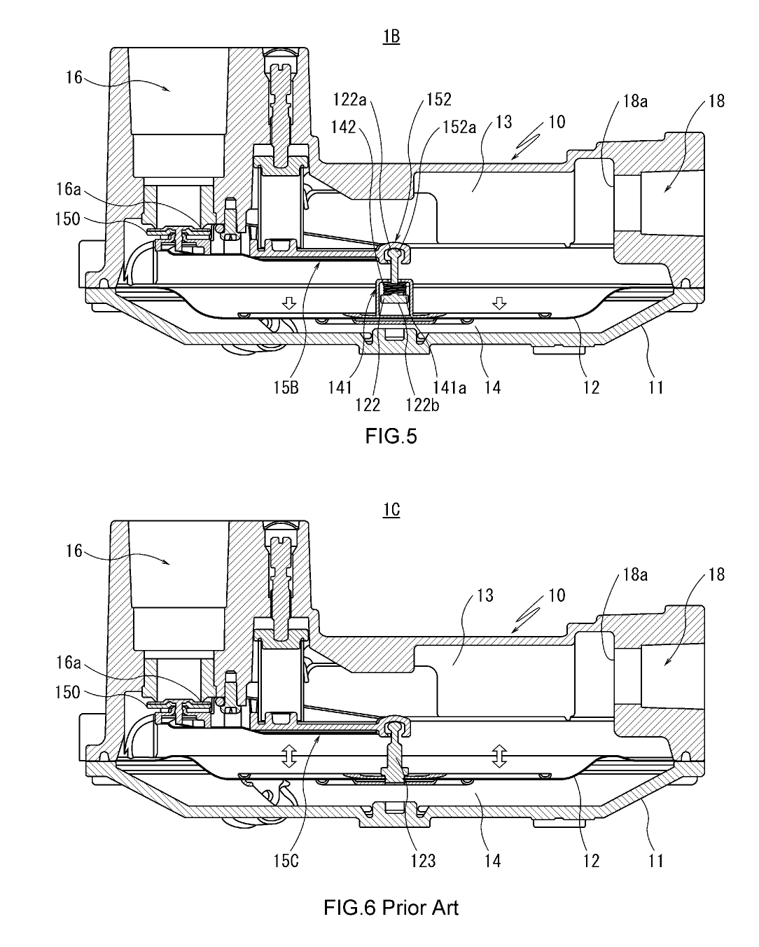

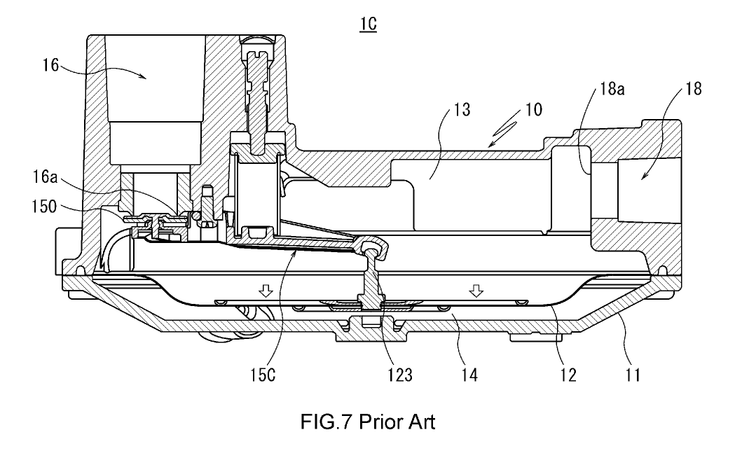

Therefore, as illustrated in FIG. 4, the diaphragm pin 122, the expanded portion 122b of which is pushed by the diaphragm 12 that has been displaced as a pressure regulating chamber 13 has a negative pressure, pushes the joint element 152 with the one end-side expanded portion 122a, thereby to allow the pressure regulating lever 15B to be operated in a valve opening direction. Meanwhile, even when the diaphragm 12 is substantially displaced in the direction of an atmospheric pressure chamber 14 in a valve-closed state illustrated in FIG. 5, the expanded portion 122b on the other end side of the diaphragm pin 122 slides in the recessed portion for connection 141a in the direction of the opening, and separates the connection of the diaphragm 12 side. An excess load being not applied to the pressure regulating lever 15B at the time of an abnormal positive pressure is similar to the above-described embodiment. Further, when the pressure regulating chamber 13 has a negative pressure, the diaphragm pin 122 and the joint element 152 are not separated and follow each other. With the configuration, a gas-fuel can be reliably regulated to have a low pressure.

However, in a case of a configuration in which the pressure regulating lever does not move in the valve opening direction according to the operation of the diaphragm 12 even when the diaphragm 12 is displaced toward the atmospheric pressure chamber 14, deterioration of followability of the pressure regulating lever 15B to pressure change of the pressure regulating chamber 13 at a normal operation is incurred. Therefore, a configuration to interpose a spring member 142 between the opening of the recessed portion for connection 141a and the expanded portion 122b of the diaphragm pin 122, in the recessed portion for connection 141a of the receiving member 141, and to constantly bias the diaphragm 12 side of the diaphragm pin 122 in the direction of the diaphragm 12 with the spring member 142 is employed.

With the configuration, when the pressure regulating chamber 13 has a negative pressure and the diaphragm 12 is displaced toward the pressure regulating chamber 13 at a normal operation as illustrated in FIG. 3, the diaphragm pin 122 pushes the base end side of the pressure regulating lever 15B to open a valve, and when the pressure regulating chamber 13 has a positive pressure and the diaphragm 12 is displaced toward the atmospheric pressure chamber 14, the diaphragm pin 122 follows the operation of the diaphragm 12 with the biasing force of the spring member 142, and the pressure regulating lever 15B pulled by the diaphragm pin 122 also follow the operation. Therefore, pressure regulating performance with high precision can be realized while excellent followability is exhibited.

Meanwhile, when the pressure regulating chamber 13 has an abnormal positive pressure, even if the diaphragm 12 is excessively displaced toward the atmospheric pressure chamber 14, as illustrated in FIG. 5, the connection of the diaphragm pin 122 with the diaphragm 12 side is cancelled while the spring member 142 in the recessed portion for connection 141a is compressed, at the point of time when the displacement of the diaphragm 12 becomes a predetermined level or more. Therefore, an excess load is not applied to the diaphragm pin 122, and deformation and damage of the diaphragm pin 122 can be reliably avoided, and thus the high pressure regulating performance can be easily maintained over a long period of time.

Note that the spring member arrange to press the diaphragm pin to the side where connection of the diaphragm pin is cancelled to secure followability can also be applied to the diaphragm pin 121 in the low-pressure regulator 1A of FIG. 1. The spring member may be arranged between the expanded portion 121a of the diaphragm pin 121 and a claw that forms an inner surface of an opening of the recessed portion for connection 151a, in the recessed portion for connection 151a of the joint element 151 of the pressure regulating lever 15A, and may just be constantly biased to press the one end side of the diaphragm pin 121 against a deepest portion of the recessed portion for connection 151a.

As described above, according to the present invention, regarding the low-pressure regulator, it goes without saying that the diaphragm pin and the joint element are not separated and follow each other to reliably regulate the gas-fuel to have a low pressure when the pressure regulating chamber has a negative pressure. Even if the pressure regulating chamber has an abnormal positive pressure and the diaphragm is substantially displaced toward the atmospheric pressure chamber, the damage/deformation in the pressure regulating mechanism is avoidable and the desired pressure regulating performance can be maintained.

1. A low-pressure regulator comprising:
a pressure regulating chamber and an atmospheric pressure chamber that are divided with a diaphragm;
a pressure regulating lever connected to the diaphragm through a diaphragm pin that is included in the pressure regulating chamber;
a valve element provided in a tip end side of the pressure regulating lever that regulates a fuel in the pressure regulating chamber to have a predetermined pressure near an atmospheric pressure and sends the fuel while opening or closing a fuel introduction port, as the pressure regulating lever swings following displacement of the diaphragm; and
a connection on a side of at least one of the pressure regulating lever and the diaphragm of the diaphragm pin, the connection being separable within a predetermined range in a direction of the atmospheric pressure chamber, the connection being between the diaphragm pin and the side of the at least one of the pressure regulating lever and the diaphragm, and the connection being separated to cancel the connection between the diaphragm and the pressure regulating lever in response to at least the pressure regulating chamber having a positive pressure of at least a predetermined level.

2. The low-pressure regulator according to claim 1, wherein
the connection between the diaphragm pin and the side of the at least one of the pressure regulating lever and the diaphragm is not separated and the diaphragm pin and the side of the at least one of the pressure regulating lever and the diaphragm follow each other in response to the pressure regulating chamber having a negative pressure, while the connection between the diaphragm pin and the side of the at least one of the pressure regulating lever and the diaphragm is separated in response to the pressure regulating chamber having the positive pressure of at least the predetermined level.
